(19) United States
(12) Patent Application Publication
(10) Pub. No.: US 2001/0032168 A1
(43) Pub. Date: Oct. 18, 2001

(54) Tradable contingent securities bundled with activity permits

(76) Inventors: Seabron Adamson, Cambridge, MA (US); Ambuj Sagar, Cambridge, MA (US)

Correspondence Address: FOLEY, HOAG & ELIOT, LLP, PATENT GROUP, ONE POST OFFICE SQUARE, BOSTON, MA, 02109, US

(21) Appl. No.: 09/756,243

(22) Filed: Jan. 8, 2001

Related U.S. Application Data
(60) Provisional application No. 60/175,015, filed on Jan. 7, 2000.

(51) Int. Cl. G06F 17/60

(52) U.S. Cl. 705/37; 705/4

(57) ABSTRACT

There is described herein a system for creating markets for risks associated with an externality. The market may provide for transfer of tradable securities whose value is contingent upon the occurrence of an externality, and that are coupled with an activity permit. Activity permits may be purchased by market participants, and are coupled with a prescribed activity that the holder may undertake. The contingent value and the maturity of the security may be based upon an estimate, at the time of issue, of the likelihood of, cost of, and/or time to an externality. After the issue of a security, the activity permit and the contingent value may be traded independently. Optionally, the activity permit and the contingent value may be restricted to a single holder.

### RELATED APPLICATIONS

This application claims the benefit of, and incorporates by reference, the entire disclosure of U.S. Provisional Patent Application No. 60/175,015 filed on Jan. 6, 2000.

### BACKGROUND OF THE INVENTION

So-called market approaches to addressing externalities suffer from significant drawbacks. A market approach may take the form of, for example, a right to emit a certain quantity of pollutants during manufacturing, with the rights limited in quantity and distributed by auction or lottery. An associated externality might be smog, an average temperature increase, or some other environmental change associated with the emission of the controlled pollutants. Even well intentioned observers may attach widely different probabilities to the likelihood of a particular externality. However, conventional market approaches do not incorporate these variations in the perceived likelihood of undesirable consequences, or allow participants to benefit from superior insight into the risk of a particular externality.

Other approaches to risk mitigation include insurance, in which parties who create the risk of an externality insure against any resulting harm. However, such insurance is generally based upon voluntary participation, and may not operate to effectively distribute risk among the responsible parties.

There remains a need for an improved market-based approach to allocating the risks and costs associated with an externality.

### SUMMARY OF THE INVENTION

There is described herein a system for creating markets for tradable instruments addressing risks associated with an externality. The market may provide for transfer of tradable securities whose value is contingent upon the occurrence of an externality, and that are coupled with an activity permit. Activity permits may be purchased by market participants, and are coupled with a prescribed activity that the holder may undertake. The contingent value and the maturity of the security may be based upon an estimate, at the time of issue, of the likelihood of, cost of, and/or time to an externality. After the issue of a security, the activity permit and the contingent value may be traded independently. Optionally, the activity permit and the contingent value may be restricted to a single holder.

### BRIEF DESCRIPTION OF DRAWINGS

The foregoing and other objects and advantages of the invention will be appreciated more fully from the following further description thereof, with reference to the accompanying drawings, wherein:

FIG. 1 is a flow chart of a method for operating a contingent securities and activity permit market;

FIG. 2 is a block diagram of the entities involved in a contingent securities and activity permit market;

FIG. 3 shows payout schedules that may be associated with a contingent security; and

FIG. 4 shows a network that may be used to host markets associated with contingent securities and activity permits.

### DETAILED DESCRIPTION OF THE PREFERRED EMBODIMENT(S)

To provide an overall understanding of the invention, certain illustrative embodiments will now be described, including a contingent security and activity permit for greenhouse gas emissions. However, it will be understood by those of ordinary skill in the art that the methods and systems described herein may be suitably adapted to any situation where a condition may be objectively measured (such that a contingency may be determined) and related to an activity (such that activity permits may be devised). The invention has particular application in those cases where the activity might produce harmful side effects of uncertain magnitude, and with an uncertain likelihood. All such adaptations and modifications that would be clear to one of ordinary skill in the art are intended to fall within the scope of the invention described herein.

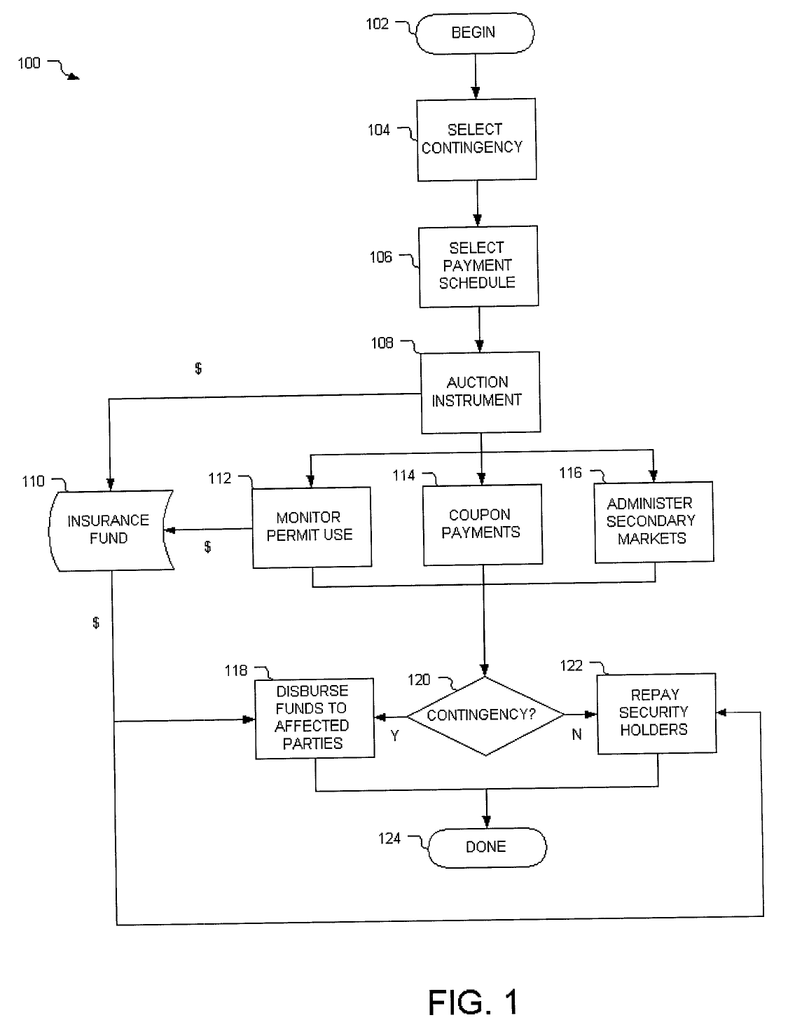

FIG. 1 is a flow chart of a method for operating a contingent securities and activity permit market. A process 100 may begin 102 with the selection of a contingency 104 associated with an activity. The activity may be, for example, emission of greenhouse gases including carbon gases. The contingency may be the occurrence of any environmental condition or objectively measurable externality associated with the activity, including increases in smog, average global or regional temperature, storm frequency, storm intensity, sea levels, and so forth. Contingencies may be triggered in many forms, such as occurrence of a contingency only after a predetermined time interval, occurrence of a contingency at any time during a predetermined time interval, or occurrence of a contingency only before a predetermined time interval, or occurrence of a contingency for a predetermined amount of a predetermined time interval.

As shown in step 106, a payment schedule may be selected for a security or instrument to be issued. The payment schedule may take the form of coupons, a single balloon payment, or some combination of these, such as coupons equal to interest and a single payment equal to a repayment of principal. One or more contingencies may also be selected to accompany the payment schedule, the contingency determining whether and in what manner the payment schedule is followed, as will be described in detail below. The interest rate may be equal to, or otherwise based upon, rates in other markets, such as corporate bond markets, U.S. Treasury bond markets, or the prime interest rate established by the Federal Reserve Board. The term for payments may be determined, for example, based upon an expected time until the occurrence of the contingency. This may vary according to the contingency. Once a contingency and a payment schedule have been selected, a contingent security may be formed and coupled with an activity permit. The complete instrument includes the activity permit along with the contingent security. The activity permit may be, for example, a right to emit a certain number of units of an industrial byproduct, such as a weight of particulates or a volume of gas.

As shown in step 108, the instrument including the activity permit and the contingent security may be auctioned. The auction may be conducted by a governmental or regulatory agency, trade or industry group, or independent third party. The party conducting the auction may also perform steps 104 and 106 to establish the features of each instrument auctioned. The auction may be a simple lottery, or may be an auction such as that used for bonds and Treasury notes, or may be an allotment according to expected or historical activity by participants, or may be through a primary market such as that provided for equities. In a lottery or allotment system, excess securities/permits, e.g., those not needed or wanted by recipients, may be auctioned to other participants. The auction may include a clearing price which caps the cost for purchasing activity permits to a predetermined price. Payments collected during the auction process may be deposited into an insurance fund 110, which may be one or more interest bearing accounts or other, preferably conservative, investment vehicles. Once an auction is complete, ongoing administration of contingent securities and activity permits may be performed.

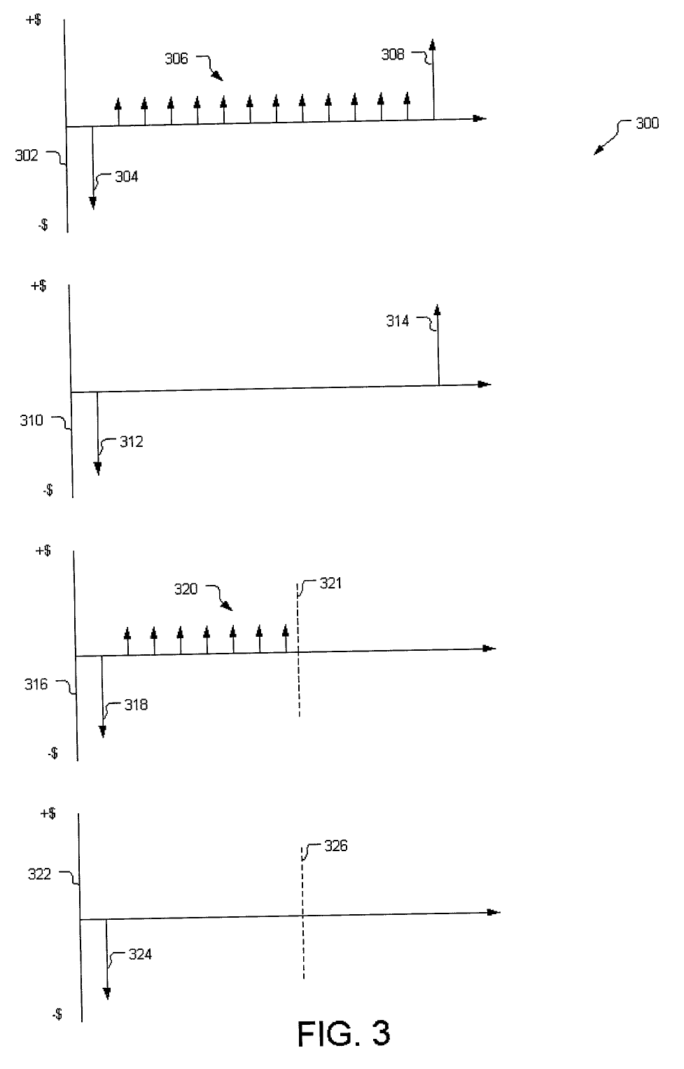

As shown in step 112, use of activity permits may be monitored. Monitoring may be performed by any of the above named groups, or by a law enforcement agency. Fines may be levied for activities in violation of permits, e.g., excess emission of regulated gases, and the fines may be paid into the insurance fund 110, or into some other supplemental fund provided for additional insurance. As shown in step 114, coupon payments may be made upon contingent securities. Some examples of coupon payments are provided below in reference to FIG. 3.

As shown in step 116, secondary markets may be administered. These may use quotation or auction pricing mechanisms such as those available for equities markets. It will be appreciated that different markets may be provided for contingent securities and activity permits. For example, activity permits and contingent securities may be decoupled in secondary markets. In this system, contingent securities whose payout depends on the occurrence of an event may be traded in a first market, with participants in the first market buying and selling contingent securities according to expected payouts. Activity permits may be traded in a second market, with participants in the second market buying and selling activity permits according to supply of, and demand for, the proscribed activity. As another example, activity permits and contingent securities may be coupled in a single market place, with participants buying and selling activity permits as needed. This latter arrangement may leave participants to enter voluntary insurance arrangements to hedge against losses due to the occurrence of contingencies.

As shown in step 120, at some point the contingency is evaluated. As noted above, a number of evaluations are possible. For example, an environmental condition may be continuously monitored for any occurrence of the contingency, or for occurrence for a certain portion of a predetermined time interval, or at the end of a predetermined period. The contingency may be, for example, an occurrence of a climatic trigger event, such as a specific, predetermined rise in mean global or regional temperature. Additionally, the contingency may trigger a partial payment, such as one-half of the principal of the contingent security, to the contingent security holder.

If the contingency occurs, the funds may be disbursed from the insurance fund 110 to affected parties or other predetermined parties, as shown in step 118. The affected parties may be determined prior to the occurrence of the contingency, or may be evaluated after occurrence of the contingency, and may include homeowners, businesses, agricultural concerns, environmental agencies, or any other party that might be exposed to costs or consequences of the harmful activity. The disbursements may be according to a predetermined formula, or may be determined by an agency or other body administering the insurance fund, or through some combination of these. The disbursements may be allocated according to actual injury, or may be distributed to predetermined parties regardless of actual injury. If the contingency does not occur, then finds from the insurance fund 110 may be distributed to any holders of the contingent securities, as shown in step 122.

Upon completion of step 118 or step 122, the process 100 is done 124. It will be appreciated that the process 100 may be repeated at fixed or varying intervals, so that new activity permits and contingent securities may be added. The process 100 may be administered in this fashion to maintain a fixed amount of permitted activity, or to increase or decrease the permitted activity over time.

The above methods may be adapted to applications where an objectively measurable criterion is not readily available, or where the accuracy of the measure or causality of the activity are disputed. As an example, the permitted activity may be a use of genetically altered organisms, such as crops, or a sale of genetically altered organisms, either alone or contained in some consumer good. Well known examples currently in use are genetically modified corn and genetically altered salmon. Potential harmful effects might be a loss of biodiversity, as well as illness and death in humans. However, measures of biodiversity, such as species counts and population counts for non-domesticated species (or even domestic species) may be imperfect. Further, the extent to which human mortality is causally linked to a particular genetically altered organism may be disputed, particularly where a number of genetically altered species are in an environment. As another example, the permitted activity may be a sale of cellular phones or other wireless devices. Potential harmful effects might include a change in the frequency and severity of brain and other soft tissue cancers. However, objectively assessing the severity of certain cancers may be difficult, and causality may not be agreed upon by participants in the wireless device market. One approach may be to agree in advance on a particular count, measure, or estimate from a predetermined source, and to assess contingencies according to the agreed measure.

Contingencies may be resolved by a panel of judges, such as a committee of experts or industry observers, who act collectively as an impartial evaluator of one or more contingencies. The panel may operate using predetermined rules or guidelines, or some other framework, or the panel may make an ad hoc determination after a predetermined time interval. The panel may receive evidence and arguments from interested parties. The panel may separately decide issues of actual causality and effects, or the panel may make a determination of a contingency regardless of causality. This latter determination may take a form such as: biodiversity in this geographical area [has/has not] decreased. Any of these techniques, or other techniques may be used, provided they result in an evaluation of a contingency that may be used to allocate insurance funds among security holders and affected parties. It will be appreciated that a panel may be suitably used to evaluate any contingency. The panel may have particular application where causality and effects are difficult to objectively determine.

It will also be appreciated that compound contingencies may be used. This may include, for example, a combination of two or more objectively measurable criteria, a weighted sum of two or more objectively measurable criteria, a product of two or more objectively measurable criteria, or any other mathematical or other combination of objectively measurable criteria.

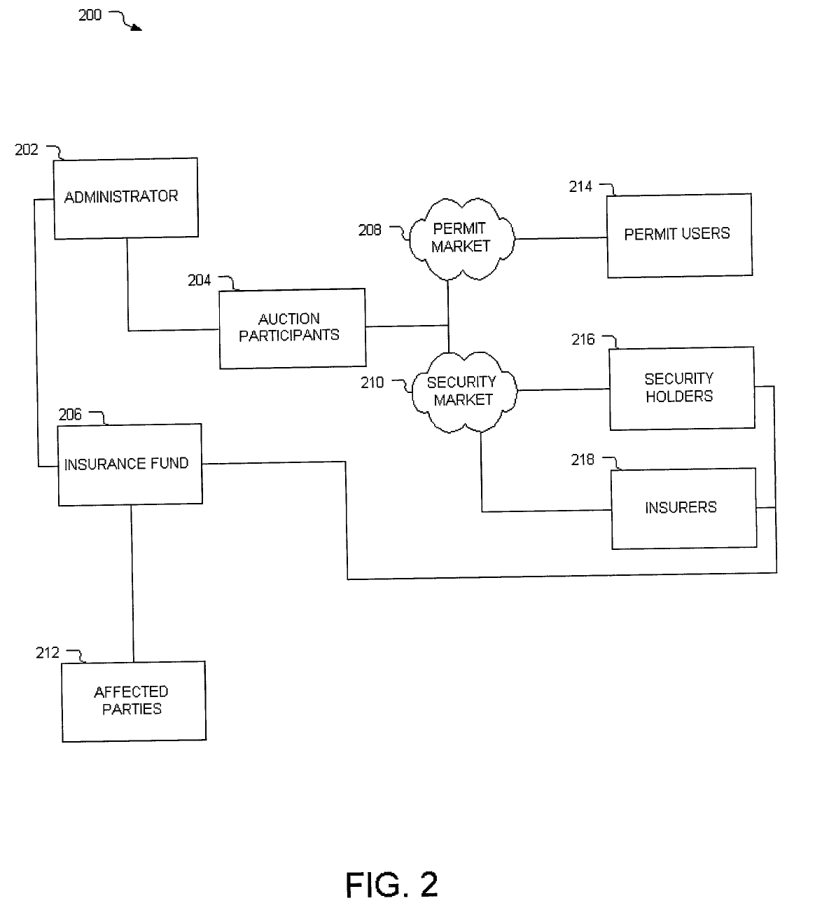

FIG. 2 is a block diagram of the entities involved in a contingent securities and activity permit market. The system 200 may include an administrator 202, one or more auction participants 204, an insurance fund 206, a permit market 208, a security market 210, one or more affected parties 212, one or more permit users 214, one or more security holders 216, and one or more insurers 218.

As noted above, the administrator may be any governmental, regulatory, or law enforcement agency, or a trade or industry group, or any other third party designated to oversee the creation of contingent securities and activity permits, as well as to administer the insurance find 206 and the secondary markets 208, 210. The administrator 202 may also be responsible for designating affected parties 212, monitoring compliance with regulated activities, and administering payments from the insurance fund 206 to security holders 216 and insurers 218 at appropriate times. The administrator 202 may charge fees for various transactions, for example, issue fees for contingent securities or trading fees for contingent securities traded in one of the secondary markets. If the administrator 202 is an independent third party, the administrator 202 may manage the systems on a fixed-fee or other contract basis. The insurance fund 206 may be one or more financial accounts managed by the administrator 202, or may be a separate entity with authority to receive funds from the administrator and invest the funds. Either the insurance fund 206 or the administrator may make determinations concerning payments to security holders 216, identify affected parties 212, and determine amounts of payments to any identified affected parties 212.

Auction participants 204 may be any parties interested in purchasing contingent securities and activity permits in an initial auction. It will be appreciated that, although shown as separate entities, the auction participants 204 may also be permit users 214 and security holders 216, and may participate in the secondary markets 208, 210 to purchase and/or sell contingent securities and activity permits.

The permit market 208 and the security market 210 may be administered in any manner suitable for trading, including the use of auction or quotation systems such as those used in markets for equities and other financial instruments. The permit market 208 and the security market 210 may also by administered using auction systems such as those employed by on-line auction companies. Examples of on-line auctions suitable for use with the permit market 208 and the security market 210 include those operated by eBay and FairMarket.

Permit users 214 may be any parties that might purchase activity permits in the permit market 208. This may depend upon the permitted activity, and may include, for example, utility companies, manufacturers, or large entertainment and recreational complexes. Security holders 216 may include the permit users 214 or any other party interested in owning contingent securities. If interest rates are competitive with, or exceed, rates available in other interest bearing investment vehicles, other investors with no interest engaging in the permitted activity may nonetheless wish to purchase the contingent securities traded in the security market 210.

Insurers 218 may participate in the security market 210. These insurers 218 may provide insurance to parties engaged in the permitted activity, or to affected parties 212, against possible costs associated with the permitted activity, and may use the contingent securities to limit or otherwise control risks associated with existing insurance policies.

The affected parties 212 may be any parties adversely affected, or potentially adversely affected by the permitted activity. The affected parties 212 may be determined by the administrator 202 when activity permits are auctioned, or the affected parties 212 may be determined by the administrator 202 when a contingency occurs. A petition system may be established by which potentially affected parties may request reparation based upon actual financial injury. The administrator 202 may then allocate funds among petitioning parties. The administrator 202 may also identify potentially affected parties and notify the potentially affected parties so that the potentially affected parties may consider whether to petition for reparations. The notification may include information concerning the permitted activity in question, the contingency, and an amount of finds available for affected parties 212.

FIG. 3 shows payout schedules that may be associated with a contingent security. In the payout schedules 300, money is represented by a vertical axis and time is represented by a horizontal axis. Money paid by a purchaser of a contingent security is represented as negative dollars (i.e., a downward arrow) while money paid to the holder of the contingent security is represented as positive dollars (i.e., an upward arrow). Although designated in dollars, it will be appreciated that any units of currency may be suitably used with the contingent securities. The initial amount paid by the purchaser may represent, for example, a price paid by a purchaser of the contingent security and activity permit in an initial auction by the administrator of FIG. 2.

In a first example 302, the purchaser obtains the contingent security by paying a purchase price 304. The purchaser (or a transferee) may then receive a stream of coupon payments 306, which may represent interest on the purchase price 304, or some portion of the interest on the purchase price 304. Upon maturity of the contingent security, the purchaser may receive a final payment 306, which may represent the purchase price 304 adjusted for any interest not included in the coupon payments 306, or adjusted for any premium above the interest included in the coupon payments 306.

In a second example 310, the purchaser obtains the contingent security by paying a purchase price 312. The purchaser (or transferee) may then receive a single payment 314 upon maturity of the contingent security that represents the purchase price plus accumulated interest (either simple or compound) on the purchase price.

In a third example 316, the purchaser obtains the contingent security by paying a purchase price 318. The purchaser (or transferee) may then receive a stream of coupon payments 320, which may represent interest on the purchase price 304, or some portion of the interest on the purchase price 304. At some time before maturity, a contingency 321 may occur. For example, seven years after issuance of a contingent security having ten years to maturity, mean regional temperature may rise one degree thus triggering a contingency. As a result, coupon payments 320 may be stopped, and no repayment of the purchase price may be provided.

In a fourth example 322, the purchaser obtains the contingent security by paying a purchase price 324. At some time before maturity, a contingency 326 may occur. As a result, no payment is made to the purchaser of interest or principal or both.

It will be appreciated that different payment schedules may be devised. For example, coupon payments may change over time, and may be adjusted according to, for example, prevailing interest rates. Intervals between coupon payments may also vary, and may be changed while the contingent security is held. Also, as noted above, contingencies may be evaluated only upon maturity, so that coupons (if any) are guaranteed. As a further example, occurrence of a contingency may trigger a partial repayment to the contingent security holder, or an amount of repayment upon maturity may be adjusted according to an environmental variable used to measure the contingency. This may take a form such as a 10% reduction in repayment of principal for each 0.1 degree increase in temperature. As a further example, the interest rate may be zero, or the interest rate may be negative, thus imposing a fee upon the purchaser of the activity permit. These and the above payment schedules are examples only, and should not be interpreted in a limiting sense.

In the case of contingent securities having two potential payoffs, either zero or the principal plus interest, the contingent security may be treated as an Arrow-Debreu pure state contingent security. Using known techniques, these contingent securities and other simple securities may be used to hedge against known risks associated with the contingent securities.

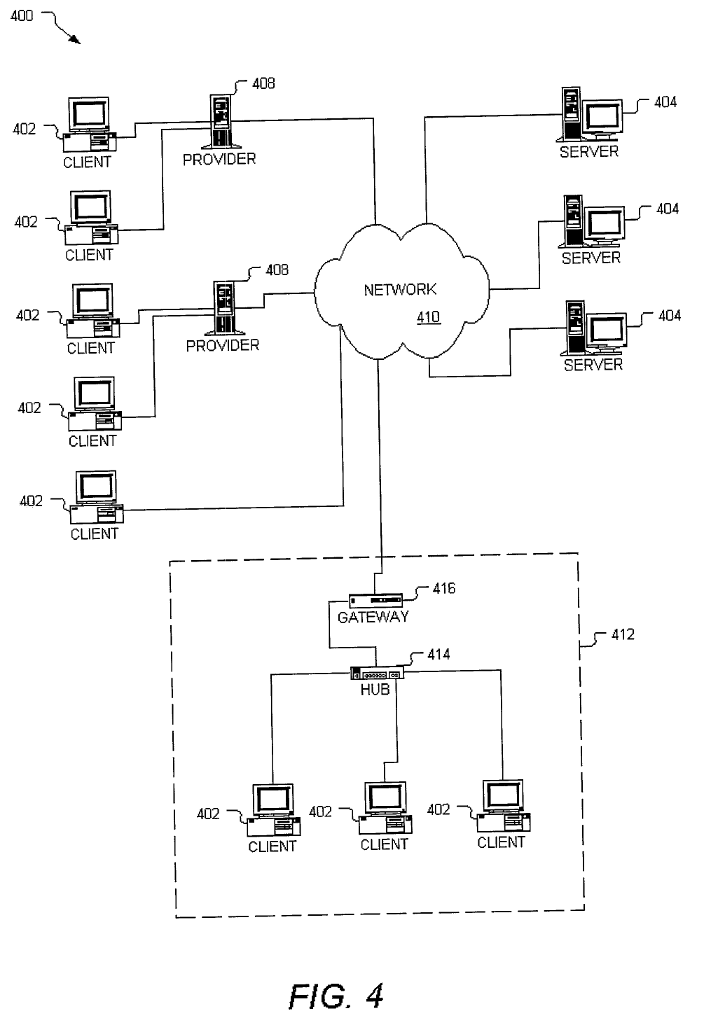

FIG. 4 shows a network that may be used to host markets associated with contingent securities and activity permits. In a system 400, a plurality of clients 402, servers 404, and providers 408 may be connected via an internetwork 410. It should be understood that any number of clients 402, servers 404, and providers 408 could participate in such a system 400. The system may further include one or more local area networks (“LAN”) 412 interconnecting clients 402 through a hub 414 (in, for example, a peer network) or a local area network server 414 (in, for example, a client-server network). The LAN 412 may be connected to the intemetwork 410 through a gateway 416, which provides security to the LAN 412 and ensures operating compatibility between the LAN 412 and the intemetwork 410. Any data network may be used as the internetwork 410 and the LAN 412.

In one embodiment, the internetwork 410 is the Internet, and the World Wide Web provides a system for interconnecting clients 402 and servers 404 through the Internet 410. In one embodiment, the internetwork 410 includes a cable network, and at least one of the clients 402 is a set-top box, cable-ready game console, or the like.

An exemplary client 402 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example o f such a client 402 is a personal computer equipped with an operating system such as Microsoft Windows 95, Microsoft Windows NT, Unix, Linux, and Linux variants, along with software support for Internet communication protocols. The personal computer may also include a browser program, such as Microsoft Internet Explorer or Netscape Navigator, to provide a user interface for access to the Internet 410. Although the personal computer is a typical client 402, the client 402 may also be a workstation, mobile computer, Web phone, television set-top box, interactive kiosk, personal digital assistant, or other device capable of communicating over the Internet 410. As used herein, the term “client” is intended to refer to any of the above-described clients 402 or other client devices, and the term “browser” is intended to refer to any of the above browser programs or other software or firmware providing a user interface for navigating an internetwork 410 such as the Internet.

An exemplary server 404 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. As used herein, the term “server” is intended to refer to any of the above-described servers 404, or any other device that may be used to provide access, functionality, or content in a networked environment.

Focusing now on the internetwork 410, one embodiment is the Internet. The structure of the Internet 410 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the internetwork 410. For a more detailed description of the structure and operation of the Internet 410, one may refer to “The Internet Complete Reference,” by Harley Hahn and Rick Stout, published by McGraw-Hill, 1994. However, one may practice the present invention on a wide variety of communication networks. For example, the internetwork 410 can include interactive television networks, telephone networks, wireless voice or data transmission systems, two-way cable systems, customized computer networks, interactive kiosk networks and automatic teller machine networks.

One embodiment of the internetwork 410 includes Internet service providers 408 offering dial-in service, such as Microsoft Network, America OnLine, Prodigy and CompuServe. It will be appreciated that the Internet service providers 408 may also include any computer system which can provide Internet access to a client 402. Of course, the Internet service providers 408 are optional, and in some cases, the clients 402 may have direct access to the Internet 410 through a dedicated DSL service, ISDN leased lines, Ti lines, digital satellite service, cable modem service, or any other high-speed connection. Any of these high-speed services may also be offered through one of the Internet service providers 408.

In its present deployment as the Internet, the internetwork 410 consists of a worldwide computer network that communicates using the well-defined Transmission Control Protocol (“TCP”) and Internet Protocol (“IP”) to provide transport and network services. Computer systems that are directly connected to the Internet 410 each have a unique IP address. The IP address consists of four one-byte numbers (although a planned expansion to sixteen bytes is underway with IPv6). The four bytes of the IP address are commonly written out separated by periods such as “64.244.158.2”. To simplify Internet addressing, the Domain Name System (“DNS”) was created. The DNS allows users to access Internet resources with a simpler alphanumeric naming system. A DNS name consists of a series of alphanumeric names separated by periods. For example, the name “www.towertech.com” corresponds to a particular IP address. When a domain name is used, the computer accesses a DNS server to obtain the explicit four-byte IP address.

It will be appreciated that other internetworks 410 may be used with the invention. For example, the intemetwork 410 may be a wide-area network, a local area network, or corporate area network. The internetwork 410 may be any other network used to communicate data, such as a cable broadcast network.

To further define the resources on the Internet 410, the Uniform Resource Locator system was created. A Uniform Resource Locator (“URL”) is a descriptor that specifically defines a type of Internet resource along with its location. URLs have the following format:

resource-type://domain.address/path-name

where resource-type defines the type of Internet resource. Web documents are identified by the resource type “http” which indicates that the hypertext transfer protocol should be used to access the document. Other common resource types include “ftp” (file transmission protocol), “mailto” (send electronic mail), “file” (local file), and “telnet.” The domain. address defines the domain name address of the computer that the resource is located on. Finally, the path-name defines a directory path within the file system of the server that identifies the resource. As used herein, the term “IP address” is intended to refer to the four-byte Internet Protocol address, and the term “Web address” is intended to refer to a domain name address, along with any resource identifier and path name appropriate to identify a particular Web resource. The term “address,” when used alone, may refer to either a Web address or an IP address.

In an exemplary embodiment, a browser, executing on one of the clients 402, retrieves a Web document at an address from one of the servers 404 via the internetwork 410, and displays the Web document on a viewing device, e.g., a screen. A user can retrieve and view the Web document by entering, or selecting a link to, a URL in the browser. The browser then sends an http request to the server 404 that has the Web document associated with the URL. The server 404 responds to the http request by sending the requested Web document to the client 402. The Web document is an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”).

Each Web document usually contains hyperlinks to other Web documents. The browser displays the Web document on the screen for the user and the hyperlinks to other Web documents are emphasized in some fashion such that the user can identify and select each hyperlink. To enhance functionality, a server 404 may execute programs associated with Web documents using programming or scripting languages, such as Perl, C, C++, or Java, or a Common Gateway Inferface (“CGI”) script to access applications on the server. Other examples may include Microsoft's Application Server Pages (“ASP”) with a Component Object Model (“COM”) interface, or Java Server Pages with a JavaBeans interface. A server 404 may also use server-side scripting languages such as ColdFusion from Allaire, Inc., or PHP. These programs and languages perform “back-end” functions such as order processing, database management, and content searching. A Web document may also include references to small client-side applications, or applets, that are transferred from the server 404 to the client 402 along with a Web document and executed locally by the client 402. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, and sound formats such as MP3 and MIDI. These media formats, along with a growing variety of proprietary media formats, may be used to enrich a user's interactive and audio-visual experience as each Web document is presented through the browser. The term “page” as used herein is intended to refer to the Web document described above, as well as any of the above-described functional or multimedia content associated with the Web document.

A server 404 may be used to host a permit market 208 or a security market 210 as described above. Purchasers and sellers may access the market by connecting to the server 404 from a client 402 through the network 110. The server 404 may be configured to present current transaction prices and volumes to participants, and to receive and process orders to buy and sell activity permits and contingent securities. The administrator 202 may also employ the server 404 (or a separate server) to auction new contingent securities and activity permits using, for example Web pages that may be accessed by clients 402.

The administrator 202 or the insurance fund 206 (if a separate entity) may use the server 404 or another server to manage and process financial transactions associated with the systems described herein. The server 404 may evaluate contingencies, and direct payments to appropriate participants at appropriate times, such as coupon payments to holders of contingent securities. The server 404 may also clear transactions between participants in the permit market 208 or the security market 210. That is where an activity permit is sold, the server 404 may electronically transfer funds from the buyer to the seller of the activity permit. The server 404 may also maintain a database of current owners of activity permits and contingent securities. The database may be available to clients 402 on a secure basis so a participant can review the activity permits and contingent securities that the participant currently owns.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for mitigating risks of climatic change comprising:
selecting a contingency that occurs upon a predetermined change in an environmental condition;
selecting a payment schedule for repayment of a principal amount;
providing a contingent security in exchange for the principal amount;
paying a holder of the contingent security according to the payment schedule if the contingency does not occur, and paying a party affected by the occurrence of the environmental condition if the contingency does occur; and
coupling a permit with the contingent security, the permit authorizing the holder to emit a quantity of a substance that is associated with changes in the environmental condition.

2. The method of claim 1 wherein the payment schedule includes one or more coupon payments prior to a maturity date of the contingent security.

3. The method of claim 1 wherein the payment schedule includes a final payment equal to the principal amount and interest upon the principal amount.

4. The method of claim 1 wherein the environmental condition includes at least one of a global mean temperature, a sea level, a frequency of storms, or an intensity of storms.

5. The method of claim 1 further comprising providing a secondary market for trading at least one of the permit or the contingent security.

6. The method of claim 1 further comprising:
decoupling the permit from the contingent security after the contingent security is issued;
providing a first secondary market for trading the permit; and
providing a second secondary market for trading the contingent security.

7. The method of claim 6 wherein a plurality of contingent securities having different payment schedules are traded in the second secondary market, and a plurality of permits authorizing emissions of different amounts of different substances are traded in the first secondary market.

8. The method of claim 1 further comprising establishing an insurance fund to hold the principal amount, the insurance fund disbursing funds upon occurrence of the contingency.

9. The method of claim 1 wherein the holder of the permit includes at least one of a business, a manufacturer, an agricultural concern, or a government agency.

10. A method of doing business comprising:
selecting a contingency that occurs upon a change in an objectively measurable condition;
selecting a payment schedule for repayment of a principal amount;
providing a contingent security in exchange for the principal amount;
coupling an activity permit with the contingent security, the permit authorizing the holder to engage in an activity;
auctioning the contingent security coupled with the activity permit to a holder; and
paying the holder of the contingent security according to the payment schedule if the contingency does not occur, and paying a party affected by the occurrence of the objectively measurable condition if the contingency does occur.

11. The method of claim 10 further comprising:
transferring the activity permit to a second holder in a first secondary market after auctioning the contingent security; and
transferring the contingent security to a third holder in a second secondary market after auction the contingent security.

12. The method of claim 10 wherein auctioning the contingent security coupled with the activity permit further comprises distributing the contingent security coupled with the activity permit through at least one of a primary market, a lottery, or an allotment, or a bond auction.

13. The method of claim 10 wherein the activity permit includes at least one of a right to sell a genetically modified organism, a right to use a genetically modified organism, or a right to sell a wireless device.

14. A method of doing business comprising:
selecting a contingency that is evaluated by a panel of judges;
selecting a payment schedule for repayment of a principal amount;
providing a contingent security in exchange for the principal amount;
coupling an activity permit with the contingent security, the permit authorizing the holder to engage in an activity;
auctioning the contingent security coupled with the activity permit to a holder; and
paying the holder of the contingent security according to the payment schedule if the panel of judges determines that the contingency does not occur, and paying another party if the panel of judges determines that the contingency does occur.

15. The method of claim 14, wherein the panel of judges includes a committee of experts.

16. The method of claim 14 wherein the contingency includes at least one of a change in biodiversity, a change in human mortality, a change in incidence of human illness, or a change in incidence of cancer.

17. A method of doing business comprising issuing a financial instrument, the financial instrument including:
a maturity date;
a final price;
a trigger event, the trigger event determining a recipient of the final price; and
a permit, the permit authorizing an entity to emit a predetermined quantity of a predetermined substance.

18. The method of claim 17 wherein the recipient is an affected party when the trigger event occurs, and wherein the recipient is a holder of the financial instrument when the trigger event does not occur.

19. The method of claim 17 further comprising a plurality of coupon payments that are made to a holder of the financial instrument according to a payment schedule.

20. The method of claim 17 wherein the trigger event includes at least one of a rise in mean temperature, a rise in sea level, an increase in storm intensity, or an increase in storm frequency.

21. The method of claim 17 wherein the substance includes greenhouse gases.

22. A computer implemented market system comprising:
a server hosting a market, the market for trading a plurality of instruments that include a security with a contingent payoff coupled to a permit to conduct a predetermined activity; and
a plurality of clients connected to the server through a network, each client participating in the market by buying or selling one of the plurality of instruments.

23. The market system of claim 22 wherein the security and the permit are decoupled and traded in separate markets, each of the separate markets being hosted by the server.

24. A market system comprising:
a market hosting means for trading a plurality of instruments that include a security with a contingent payoff coupled to a permit to conduct a predetermined activity; and
a market participant means connected to the market hosting means for receiving orders to exchange at least one of the security and the permit in a secondary market, the market hosting means executing the received orders.
